(19) United States
(12) Patent Application Publication
(10) Pub. No.: US 2006/0237030 A1
(43) Pub. Date: Oct. 26, 2006

(54) Method and apparatus for cleaning and surface conditioning objects with plasma

(75) Inventor: Paul Fredric Hensley, Moorestown, NJ (US)

Correspondence Address: RAYMOND R. MOSER JR., ESQ.;MOSER IP LAW GROUP, 1040 BROAD STREET, 2ND FLOOR, SHREWSBURY, NJ, 07702, US

(73) Assignee: Cerionx, Inc.

(21) Appl. No.: 11/112,785

(22) Filed: Apr. 22, 2005

(51) Int. Cl. B08B 6/00; C23F 1/00

(52) U.S. Cl. 134/1.1; 156/345.45

(57) ABSTRACT

A method and apparatus for cleaning and surface conditioning objects using plasma are disclosed. An embodiment of the method discloses providing a plurality of elongated dielectric barrier members, the members having inner electrodes connected therein, providing a plurality of blocking members within predetermined gaps between the elongated dielectric barrier members, introducing the objects proximate the elongated dielectric barrier members and blocking members, and producing a dielectric barrier discharge to form plasma between the objects and both members for cleaning at least a portion of the objects. An embodiment of the apparatus for cleaning objects using plasma discloses a plurality of elongated dielectric barrier members arranged adjacent each other and defining a predetermine gap therebetween, a plurality of inner electrodes, each contained within, and extending substantially along the length of, respective ones of the elongated dielectric barrier members, and a plurality of blocking members positioned between the elongated dielectric barrier members and within the predetermined gaps.

### CROSS-REFERENCE TO RELATED APPLICATIONS

This application is related to co-pending patent application, entitled “Atmospheric Pressure Non-Thermal Plasma Device to Clean and Sterilize the Surfaces of Probes, Cannulas, Pin Tools, Pipette and Spray Heads,” assigned Ser. No. 10/858,272, filed Jun. 1, 2004; co-pending patent application entitled “Method and Apparatus for Cleaning and Surface Conditioning Objects Using Non-Equilibrium Atmospheric Pressure Plasma,” assigned Ser. No. 11/040,222, filed Jan. 21, 2005; and co-pending patent application entitled “Method and Apparatus for Cleaning and Surface Conditioning Objects With Plasma,” assigned Ser. No. 11/043,787, filed Jan. 26, 2005, all three disclosures of which are commonly assigned with the present invention and are incorporated herein by reference in their entirety.

### BACKGROUND OF THE INVENTION

1. Field of the Invention

Embodiments of the present invention relate to a method and apparatus for cleaning and surface conditioning objects, such as fluid handling devices, and in particular to a method and apparatus for cleaning and surface conditioning portions of fluid handling devices with non-equilibrium atmospheric pressure plasma.

2. Description of the Related Art

In certain clinical, industrial and life science testing laboratories, extremely small quantities of fluids, for example, volumes between a drop (about 25 micro-liters) to a few nano-liters may need to be analyzed. Several known methods are employed to transfer these small amounts of liquid compounds from a source to a testing device. Generally, liquid is aspirated from a fluid holding device to a fluid-handling device. The fluid-handling device may include, but is not limited to, a probe, cannula, disposable pipette, pin tool or other similar component or plurality of such components (collectively referred to as “probes”). The fluid handling device and its probes may move, manually, automatically or robotically, dispensing the aspirated liquid into another fluid handling device for testing purposes.

Commonly, the probes, unless disposable, are reused from one test to the next. As a result, at least the tips and perhaps additional portions of the probes must be cleaned between each test to avoid cross contamination. Conventionally, the probes undergo a wet “tip wash” process. That is, they are cleaned in between uses with a liquid solvent, such as Dimethyl Sulfoxide (DMSO) or simply water.

These known methods and apparatus for cleaning and conditioning fluid handling devices have certain disadvantages. For example, the wet “tip wash” process takes a relatively long amount of time and can be ineffective in cleaning the probe tips to suitable levels of cleanliness. Furthermore, disposing of the used solvents from the wet process presents environmental and cost issues. Thus, there is a need for improved methods and apparatus for cleaning and surface conditioning fluid handling devices.

### SUMMARY OF THE INVENTION

The present invention generally relates to a method and apparatus for cleaning objects using plasma. These objects include, but are not limited to, probes of a fluid handling device, and the like.

An embodiment of the present invention provides an apparatus comprising a plurality of elongated dielectric barrier members, arranged adjacent each other and spaced apart to define predetermined gaps therebetween; a plurality of inner electrodes, each contained within, and extending substantially along the length of, respective ones of the elongated dielectric barrier members; and a plurality of blocking members arranged between the plurality of elongated dielectric barrier members and extending into the predetermined gaps therebetween.

In accordance with another embodiment of the present invention, there is provided a method for cleaning a plurality of non-conductive objects, comprising: providing a plurality of elongated dielectric barrier members, each having inner electrodes arranged therein, the elongated dielectric barrier members spaced apart to define a predetermined gap therebetween; providing blocking members within the predetermined gaps; providing a plurality of ground electrodes adjacent the elongated dielectric barrier members; introducing non-conductive objects proximate the elongated dielectric barrier members, the blocking members and the ground electrodes; and generating a dielectric barrier discharge to form plasma among the elongated dielectric barrier members, blocking members and respective ground electrodes for cleaning at least a portion of each of the non-conductive objects.

### BRIEF DESCRIPTION OF THE DRAWINGS

So the manner in which the above recited features of the present invention can be understood in detail, a more particular description of embodiments of the present invention, briefly summarized above, may be had by reference to embodiments, some of which are illustrated in the appended drawings. It is to be noted; however, the appended drawings illustrate only typical embodiments of the present invention and are therefore not to be considered limiting of its scope, for the present invention may admit to other equally effective embodiments.

FIG. 1A is a perspective view depicting a plurality of conductive probes introduced to a plurality of elongated dielectric barrier members, having inner electrodes coupled to an AC voltage supply, and blocking members located between the elongated dielectric barrier members in accordance with an embodiment of the present invention;

FIG. 1B is a partial, cross sectional schematic view showing the blocking member of FIG. 1A;

FIG. 2 is a cross sectional schematic view depicting a non-conductive probe introduced to a pair of elongated dielectric members having inner electrodes, a ground electrode, and a blocking member arranged between the pair of dielectric barrier members in accordance with an embodiment of the present invention;

FIG. 3 is a cross sectional schematic view depicting non-conductive probes introduced to a pair of dielectric barrier members, a ground electrode and two blocking members arranged between the dielectric barrier members and the center ground electrode in accordance with another embodiment of the present invention;

FIG. 4 is a cross sectional view of an embodiment of a blocking member in accordance with an embodiment of the present invention;

FIG. 5 is a top plan view of blocking members in accordance with another embodiment of the present invention;

FIG. 6 is a partial, cross section view of blocking members in accordance with another embodiment of the present invention;

FIG. 7 is a top plan view of a matrix or array of any one of the preceding devices showing the plurality of elongated dielectric barrier members and plurality of blocking members arranged in a micro tighter member format; and

FIG. 8 represents a graph of the relative concentrations of different chemical and particle species of plasma in time after the initiation of a single microdischarge that forms atmospheric pressure plasma in air.

While embodiments of the present invention are described herein by way of example using several illustrative drawings, those skilled in the art will recognize the present invention is not limited to the embodiments or drawings described. It should be understood the drawings and detailed description thereto are not intended to limit the present invention to the particular form disclosed, but on the contrary, the present invention is to cover all modifications, equivalents and alternatives falling within the spirit and scope of embodiments of the present invention as defined by the appended claims.

The headings used herein are for organizational purposes only and are not meant to be used to limit the scope of the description or the claims. As used throughout this application, the word “can” is used in a permissive sense (i.e., meaning having the potential to), rather than the mandatory sense (i.e., meaning must). Similarly, the words “include,” “including,” and “includes” mean including, but not limited to. To facilitate understanding, like referenced numerals have been used, where possible to designate like elements common to the figure.

### DETAILED DESCRIPTION

The term “plasma” is used to describe a quasi-neutral gas of charged and neutral species characterized by a collective behavior governed by coulomb interactions. Plasma is typically obtained when sufficient energy, higher than the ionization energy of the neutral species, is added to the gas causing ionization and the production of ions and electrons. The energy can be in the form of an externally applied electromagnetic field, electrostatic field, or heat. The plasma becomes an electrically conducting medium in which there are roughly equal numbers of positive and negatively charged particles, produced when the atoms/molecules in a gas become ionized.

A plasma discharge is produced when an electric field of sufficient intensity is applied to a volume of gas. Free electrons are then subsequently accelerated to sufficient energies to produce electron-ion pairs through inelastic collision. As the density of electrons increase, further inelastic electron atoms/molecule collisions will result in the production of further charged carriers and a variety of other species. The species may include excited and metastabled states of atoms and molecules, photons, free radicals, molecular fragments and monomers.

The term “metastable” means a type of atom/molecule excited to an upper electronic quantum level in which quantum mechanical selection rules forbid a spontaneous transition to a lower level. As a result, such species have long excited lifetimes. For example, whereas excited states with quantum mechanically allowed transitions typically have lifetimes on the order of 10⁻⁹ to 10⁻⁸ seconds before relaxing and emitting a photon, metastable states can exist for about 10⁻⁶ to 10¹ seconds. The long metastable lifetimes allow for a higher probability of the excited species to transfer their energies directly through a collision with another compound and result in ionization and/or disassociative processes.

The plasma species are chemically active and/or can physically modify the surface of materials and may therefore serve to form new chemical compounds and/or modify existing compounds. For example, the chemically active plasma species can modify existing compounds through ionization, dissociation, oxidation, reduction, attachment and recombination.

A non-thermal, or non-equilibrium, plasma is one in which the temperature of the plasma electrons is higher than the temperature of the ionic and neutral species. Within atmospheric pressure non-thermal plasma, there is typically an abundance of the aforementioned energetic and reactive particles (i.e., species), such as ions, excited and/or metastable atoms and molecules, and free radicals. For example, within an air plasma, there are excited, metastables and ionic species of N₂, N, O₂, O, free radicals such as OH, HO₂, NO, O, and O₃, and ultraviolet photons ranging in wavelength from 200 to 400 nanometers resulting from N₂, NO, and OH emissions. In addition to the energetic (fast) plasma electrons, embodiments of the present invention harness and use these “other” particles to clean and surface condition portions of liquid handling devices such as probes, and the like.

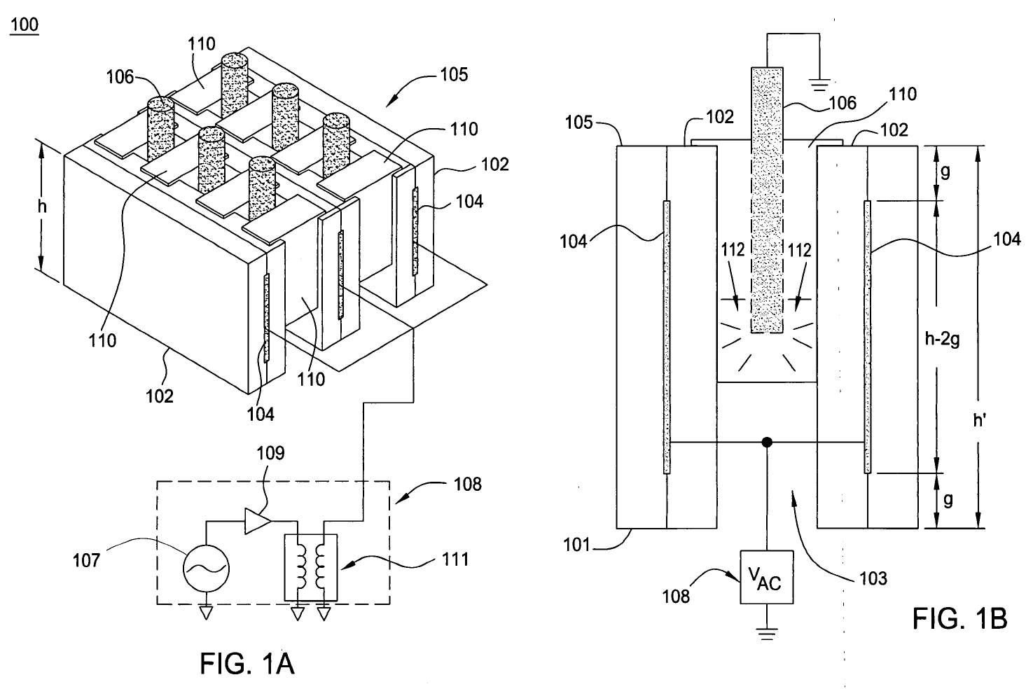

FIG. 1A is a perspective view of a portion of a non-thermal atmospheric pressure plasma-cleaning device 100 in accordance with an embodiment of the present invention. The device 100 includes a plurality of elongated dielectric barrier members 102 arranged in a matrix or array and extending along a given plane. The elongated dielectric barrier members 102 have a height “h” defined between a top 105 and a bottom 101. The dielectric barrier members 102 are substantially regularly spaced apart from each other, forming a predetermined gap 103 between adjacent dielectric barrier members 102. Each elongated dielectric barrier member 102 includes an inner electrode 104 extending within, and substantially along the length of, respective elongated dielectric barrier members 102. A plurality of objects, for example, conductive probes 106 are introduced between the members 102 in the predetermined gaps 103.

A plurality of blocking members 110 are bridged between the dielectric barrier members 102 and extend downwardly into the predetermined gaps 103. The blocking members 110 are spaced apart from each other to define an opening for receiving the probes 106. The plurality of blocking members are situated as such between the dielectric barrier members 102 in the predetermined gaps 103 so as to cause a blocking of the space in the predetermining gaps not occupied by the introduced probes. These blocking members 110 act as a means for controlling the location and flow of plasma that is generated between the dielectric barrier members 102 and towards at least the tips of the probes 106. The amount of plasma needed to perform the cleaning and surface conditioning of the probes is reduced as well. This leads to the advantage of using less power to generate the plasma needed to clean and surface condition the objects, e.g., probes.

In one embodiment, the probes 106 are part of the fluid-handling device (not shown). As such, the probes 106 are attached to, and extend from, a fluid handling device, which may be part of a microtiter member test bed setup. In another embodiment, the probes 102 may be any form of a conductive object or element that would benefit from plasma cleaning and surface conditioning.

When referring to the use of “plasma” as a means for cleaning, it is to be understood this may include the initial atmospheric pressure plasma formed from a dielectric barrier micro discharge and created between the elongated dielectric barrier members and the conductive objects, as well as “other” particles or species described herein that remain relatively long after the initial plasma has dissipated. In this embodiment, such creation of micro discharges will occur and be located between and among the dielectric barrier members 102 and the blocking members 110.

The blocking members in this embodiment are made of dielectric material similar to the dielectric material of the dielectric barrier members 102, discussed herein. The elongated dielectric barrier members 102 and the blocking members 110 can also be made of any type of material capable of dividing an area or surface for a dielectric barrier discharge of atmospheric pressure plasma (described herein). Dielectric barrier material that can be used in other embodiments of the present invention includes, but is not limited to, ceramic, glass, plastic, polymer epoxy or a composite of one or more such materials, such as fiberglass or a ceramic filled resin (available from Cotronics Corp., Wetherill Park, Australia) and the like.

In one embodiment, a ceramic dielectric barrier is alumina or aluminum nitride. In another embodiment, a ceramic dielectric barrier is a machinable glass ceramic (available from Corning Incorporated, Corning, N.Y.). Yet another embodiment of the present invention, a glass dielectric barrier is a borosilicate glass (also available from Corning Incorporated, Corning, N.Y.). In still another embodiment, a glass dielectric barrier is quartz (available from GE Quarts, Inc., Willoughby, Ohio). In an embodiment of the present invention, a plastic dielectric barrier is a polymethyl methacrylate (PLEXIGLASS and LUCITE, available from Dupont, Inc., Wilmington, Del.). In yet another embodiment of the present invention, the plastic dielectric barrier is polycarbonate (also available from Dupont, Inc., Wilmington, Del.). In yet another embodiment, a plastic dielectric barrier is a floropolymer (available from the Dupont, Inc. Wilmington, Del.). In another embodiment, a plastic dielectric barrier is a polyamide film (KAPTON, available from Dupont, Inc., Wilmington, Del.). Dielectric barrier materials useful in the present invention typically have dielectric constants ranging between 2 and 30. For example, in one embodiment that uses a polyimide film plastic such as KAPTON at 50 percent relative humidity with a dielectric strength of 7700 volts/mil, the film would have a dielectric constant of about 3.5.

Each of the plurality of blocking members 110 may also be made of non-dielectric material or inert material or non-conductive material. In an embodiment, the material of the blocking members 110 is of no specific dielectric material having no specific dielectric properties. Blocking members 110 fit substantially flush against the sides of the dielectric barrier members 102.

The inner electrode in 104 may comprise any conductive material, including metals, alloys, and conductive compounds. In one embodiment, a metal may be used. Metals useful in this embodiment of the present invention include, but are not limited to, copper, silver, aluminum, and combinations thereof. In another embodiment of the present invention, an alloy of metals may be used as the inner electrode 104. Alloys useful in this embodiment of the present invention include, but are not limited to, stainless steel, brass, bronze, and the like. In another embodiment of the present invention, a conductive compound may be used. Conductive compounds useful in the present invention include, but are not limited to, indium-tin-oxide, and the like.

The inner electrodes 104 of embodiments of the present invention may be formed using any method known in the art. In one embodiment of the present invention, the inner electrodes 104 may be formed using a foil. In another embodiment of the present invention, the inner electrodes 104 may be formed using a wire. In yet another embodiment of the present invention, the inner electrodes 104 may be formed using a solid piece of conductive material. In another embodiment of the present invention, the inner electrodes 104 may be deposited as an integral layer directly onto the inner core of the elongated dielectric barrier members 102. In one such embodiment, an inner electrode 104 may be formed using a conductive paint, which is applied and adhered to the inner core of the elongated dielectric barrier members 102.

The inner electrodes 104 are electrically connected to an AC voltage source 108. Alternatively, the inner electrodes 104 can be connected to a D.C. source. The conductive probes 106 are electrically grounded with respect to the AC voltage source 108. The AC voltage source 108 in this embodiment includes an AC source 107, a power amplifier 109 and a transformer 111, to supply voltage to the inner electrodes 104.

In one embodiment of the present invention, the conductive probes 106 extend from a fluid-handling device approximate the elongated dielectric barrier members 102 and the blocking members 110. The probes, 106, as shown, may also be introduced into the gap 103 between the dielectric barrier members 102 and the blocking members 110. Use of the term “probe” includes, but is not limited to, probes, cannulas, pin tools, pipette, pipe heads and spray heads or any portion of a fluid handling device capable of carrying fluid. These probe portions 106 are generally hollow in order to retain the fluid under test. The probes may be alternatively solid and include a surface area capable of retaining fluid. All of these different types of fluid handling portions of a fluid-handling device are collectively referred to in this application as “probes.” In an embodiment, the probe is conductive and is made of conductive material similar to that material described above in connection with the inner electrode 104.

FIG. 1B depicts a cross sectional schematic view of a pair of elongated dielectric barrier members 102 from the device 100 showing a blocking member 110 arranged between the pair of dielectric barrier members 102. Likewise, inner electrodes 104 are disposed within, and extend substantially along, the length of the pair of members 102. In this embodiment, the inner electrodes 104 have a height “h′ ” that is less than the height “h” of the elongated dielectric barrier members 102. As depicted in FIG. 1B, the height h′ of each inner electrode is h-2g, where “g” is the distance from each end of the inner electrode to the top 105 and bottom 101 portions of each elongated dielectric barrier member 102. In this embodiment, the distance is substantially the same amount “g” for each side. As such, the inner electrodes 104 are substantially equidistant from the top 105 and bottom 101 of the elongated dielectric barrier members 102. One advantage of this arrangement of each inner electrode 104 within each member 102 is to reduce or eliminate arcing between the inner electrodes 104 and the conductive probes 106, in operation when the probes 106 are introduced to the members 102.

When a conductive probe 106 is introduced to the elongated dielectric barrier members 102 and between the blocking members 110 within the predetermined gap 103, and power from the AC voltage source 108 is supplied to the inner electrodes 104, microdischarges or a dielectric barrier discharge 112 is generated between the probes 106, the elongated dielectric barrier members 102, and the blocking members 110, at least at or near the tip of the probes 106.

As a result of the blocking members, which in an embodiment could be shaped as a wedge (see below), the micro-discharges or dielectric barrier discharges 112 are contained in an area where the tip of the probe 106 is in contact with the plasma for cleaning purposes. An advantage is that the plasma generated is limited to this area and is not generated in other areas that would not be used to clean the probe 106. Therefore the amount of plasma needed to be generated to clean to probe is reduced.

In the embodiments described herein, a dielectric barrier discharge (DBD) (also known as a “silent discharge”) technique is used to create micro-discharges of atmospheric pressure plasma. In a DBD technique, a sinusoidal voltage, for example, from the AC voltage source 107 is applied to at least one inner electrode 104, within an insulating dielectric barrier member 102. Dielectric barrier discharge techniques are described more fully in “Dielectric-barrier Discharges: Their History, Discharge Physics, and Industrial Applications”, Plasma Chemistry and Plasma Processing, Vol. 23, No. 1, March 2003, and “Filamentary, Patterned, and Diffuse Barrier Discharges”, IEEE Transactions on Plasma Science, Vol. 30, No. 4, August 2002, both authored by U. Kogelschatz, the entire disclosures of which are incorporated by reference herein.

To obtain substantial uniform and atmospheric pressure plasma in air, a dielectric barrier is placed in between a voltage electrode such as the electrodes 104 and the conductive probe 106 to control the discharge, i.e., choke the production of atmospheric pressure plasma. The further control of the plasma discharge is achieved by the placement of the blocking members 110 between the dielectric barrier members 102 and the probes 106. Before the discharge can become an arc, the dielectric barrier 102 and the blocking members 110 choke the production of the discharge.

Because this embodiment is operated using an AC voltage source, the discharge oscillates in a sinusoidal cycle. The micro-discharges occur near the peak of each sinusoid. One advantage of this embodiment is that controlled non-equilibrium plasmas and resulting species can be generated at atmospheric pressure using a relatively simple and efficient technique. Furthermore, with the introduction of the blocking members 110, the amount of energy needed to create the micro-discharge is reduced in proportion to the area displaced by the blocking members 110. Unnecessary generation of plasma, which would not be used or needed to clean and surface condition the probes 106, is substantially eliminated.

In an alternate embodiment, with reference to FIG. 1B, for example, but equally applied to all other embodiments of the dielectric members throughout this application, the members 102 can be canted or angled off the vertical. Likewise, the blocking members 110 will follow the canted or angled structure and fit substantially flush against the inner sides of the dielectric barriers acting as a wedged-shaped member. This creates a narrowing of the gap 103 at the bottom portion of the members 102.

For example, in one embodiment, the members move closer to each other from the top 105 to the bottom 101. Thus, as the probe 106 is introduced to the gap 103 from the top 105 to the bottom 101 of the members, the space between the probe 106 in the adjacent members and blocking members 110 is reduced. In this configuration, because the dielectric barrier members 102 are closer and the blocking members 110 are closer to each other and thus the electrodes are closer, plasma can be formed at a lower turn-on voltage. In other words, use of the canted design, with the blocking members 110 in position, allows the device to create plasma at a relatively lower power level. In an embodiment, the degree of offset ranges from about 0° to 10°. In another embodiment, the degree of offset ranges from about 3° to about 6°. Alternatively, the canting can be other than off the vertical. It can vary, for example, in any manner that provides the production of plasma at a lower power level.

In an alternative configuration, the ground electrode as described herein may comprise a mesh. The mesh forms a physical dispersal mechanism that prevents excess electrical flow to any point. This assists in preventing arcing or uneven plasma formation.

With the addition of the blocking members 110, the area at the tip of the probe 106 toward the bottom of the members 102 at location 101, there is an area created smaller in volume than the area toward the top of the members 102 at location 105. In this regard, a Venturi effect is created. That is, the gas (e.g., air) flowing from the top of the dielectric barrier members 102, at location105 to the bottom of the dielectric barrier members 102 at location 101 passing through the varying constriction experiences a change in velocity and pressure. Through the Venturi effect, the flow of air speeding past this area increases in velocity as it flows past the probe tip 106. This increase in velocity of the airflow and decrease in the pressure in that area causes a slight vacuum, which increases the amount of withdraw byproducts from the probe tips. This effectively causes the removal of contaminants away from the tips in an advantageous and effective manner.

In operation, in accordance with an embodiment of the present invention, the AC voltage source 108 applies a sinusoidal voltage to the inner electrodes 104. Then, the plurality of the conductive probes 106 are introduced into the gap 103 between adjacent and elongated dielectric barrier members 102 and blocking members 110. A dielectric barrier discharge (DBD) is produced. The DBD forms atmospheric pressure plasma represented by arrows 112. In an embodiment of the present invention, atmospheric pressure plasma is obtained, when during one phase of the applied AC voltage charges accumulate between the dielectric surface and the opposing electrode and between the blocking members 110 until the electric field is sufficiently high enough to initiate an electric discharge through the gas gap (also known as “gas breakdown”). During an electrical discharge, an electric field from the redistributed charge densities may oppose the applied electric field and the discharge is terminated. In one embodiment, the applied voltage discharge termination process may be repeated at a higher voltage portion of the same phase of the applied AC voltage or during the next phase of the applied AC voltage.

To create the necessary DBD for an embodiment of the present invention, the AC voltage source 108 includes an AC power amplifier 109 and a high voltage transformer 111. The frequency ranges from about 10,000 Hertz to 20,000 Hertz, sinusoidal. The power amplifier has an output voltage of from about 0 Volts (rms) to 22.5 Volts (rms) with an output power of 500 watts. The high voltage transformer ranges from about 0 V (rms) to 7,000 Volts (rms) (which is about 10,000 volts (peak)). Depending on the geometry and gas used for the plasma device, the applied voltages can range from about 500 to 10,000 Volts (peak), with frequencies ranging from line frequencies of 50 Hertz up to 20 Megahertz.

In an embodiment of the present invention, the frequency of a power source may range from 50 Hertz up to 20 Megahertz. In another embodiment of the present invention, the voltage and frequency may range from 5,000 to 15,000 Volts (peak) and 50 Hertz to 50,000 Hertz, respectively.

The gas used in the plasma device 200 of the present invention can be ambient air, pure oxygen, any one of the rare gases, or a combination of each such as a mixture of air or oxygen with argon and/or helium. Also, the gas may include an additive, such as hydrogen peroxide, or organic compounds such as methanol, ethanol, ethylene or isopropynol to enhance specific atmospheric pressure plasma cleaning properties.

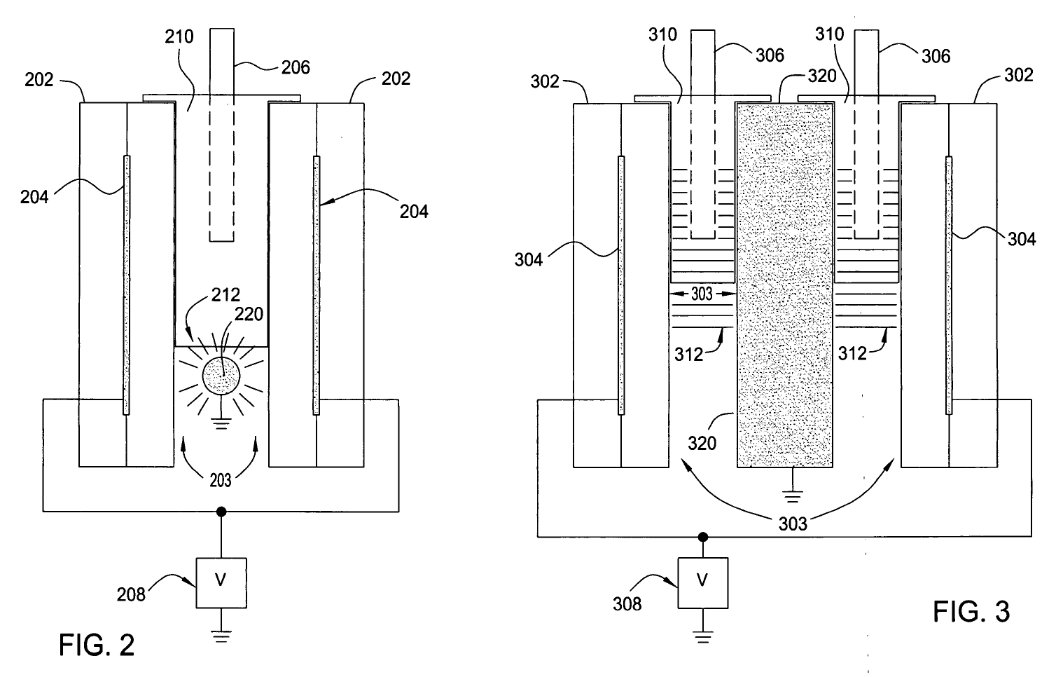

Referring now to FIG. 2, elongated dielectric barrier members 202 and blocking members 210, similar to those described with respect to FIGS. 1A and 1B are depicted. Inner electrodes 204 and AC voltage source 208 are similar to those previously described. In addition, this embodiment includes a ground electrode 220. The ground electrode 220 is positioned within the gap 203 between the two elongated dielectric barrier members 202 and between the plurality of blocking members 210. The ground electrode 220 is electrically grounded with respect to the AC voltage source 208. The ground electrode 220 can be covered by, or coated with, a non-conductive, dielectric material, which may comprise the same material as that described herein with respect to the dielectric barrier members 202 and/or the blocking members 210.

With the ground electrodes 220 in place, the probe 206 can be non-conductive. For example, the probe 206 can be made of plastic or any other type of material that does not conduct a current and as such would not cause a discharge to occur. In this way, the probe is not needed to create the DBD and therefore does not need to be limited to conductive material. Rather, the DBD 212 is created between the members 202 and the ground electrode 220 for treating or cleaning at least a portion of the non-conductive probe 206. The ground electrode 220 is shaped as a sphere or an elongated cylinder or rod. However, it can be any shape provided it functions as a ground electrode. For example, it can be an elongated square, rectangle, oval, polygon, triangle or irregular geometric shape.

FIG. 3 depicts elongated dielectric barrier members 302 and blocking members 310 similar to those previously described. Inner electrodes 304 and an AC voltage source 308, similar to those previously described, are also depicted in FIG. 3. In addition, this embodiment includes a ground electrode 320. The ground electrode 320 is positioned within the predetermined gap 303 between the two elongated dielectric barrier members and the plurality of blocking members 310. The ground electrode 320 is electrically grounded with respect to the AC voltage source 308. With the ground electrode 320 in place, as discussed previously, the probes 306 can be non-conductive. Given the shape and size of this ground electrode 320, at least two non-conductive probes 206 may be introduced between the dielectric barrier members 302 and the blocking members 310. The probes 206 can be cleaned through the process described herein. The ground electrode 320 is depicted as an elongated-like rectangle. However, it is to be understood the shape can be selected from any one of the following shapes: spherical, square, rectangular, oval, polygonal, triangular and irregularly geometric.

In an alternative embodiment, the ground electrode 320 may be covered with a dielectric material similar to that dielectric material described herein. In this configuration, the covered ground electrode 320 can be connected to ground. The next adjacent dielectric member 302 with inner electrode 304 is connected to the AC source 308.

The elongated dielectric barrier members 302 are placed adjacent each other, defining a plane. Alternatively, the members 302 and the blocking members 310 may be staggered in a non-planar arrangement with respect to one another. The gap 303 is sized to allow at least a portion of each of the plurality of probes 306 to be introduced between the elongated dielectric barrier members 302 and the blocking members 310. The gap 303 can range from about 0 mm to about 10 mm. The gap 303 may also range from about 2 mm to about 9.5 mm. In one embodiment, the gap 303 is about 9 mm. In another embodiment, the gap is about 4.5 mm. In yet another embodiment, the gap is about 2.25 mm. The gap between the blocking members 310 is sufficiently sized to receive the probe 306.

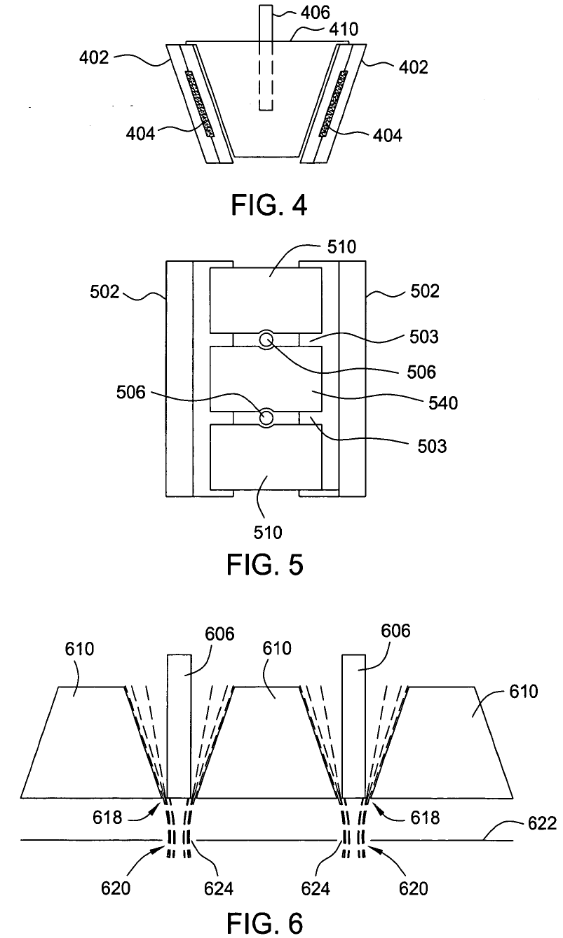

Referring to FIG. 4, in one embodiment, the blocking members 410 are wedge shaped and form fitting substantially flush against the sides of the canted or vertically angled dielectric barrier members 402.

Referring to FIG. 5, which is a top plan view of an embodiment of the present invention, the plurality of blocking members 510 are shown wedged between dielectric barrier members 502 and surrounding the opening 503, which allows for the probes 506 to enter the opening between the dielectric barrier members 502 and the plurality of blocking members 510. In this embodiment, the blocking members 510 are positioned so they extend outwardly around the area of the probes 506 to allow for a minimum amount of space around the probes to advantageously provide the least amount of airflow in that area and thereby the least amount of plasma to be generated other than what is necessary to clean the probe tips.

FIG. 6 depicts a cross section, partial view of an embodiment of the present invention showing the blocking members 610 having a narrow portion toward the top 605 of the dielectric barrier members 602 and a wide portion toward the bottom 601 of the dielectric barrier members 602. As shown, the flow of air or other gas which may flow from top to bottom increases in velocity as shown by gas flow 618 at the probe tip. Again, this creates a Venturi effect at the probe tip and advantageously removes waste and contaminants after a cleaning process has occurred. This increased velocity and lowering of pressure causes the removal of contaminants in an efficient manner through a base 622 having openings 624.

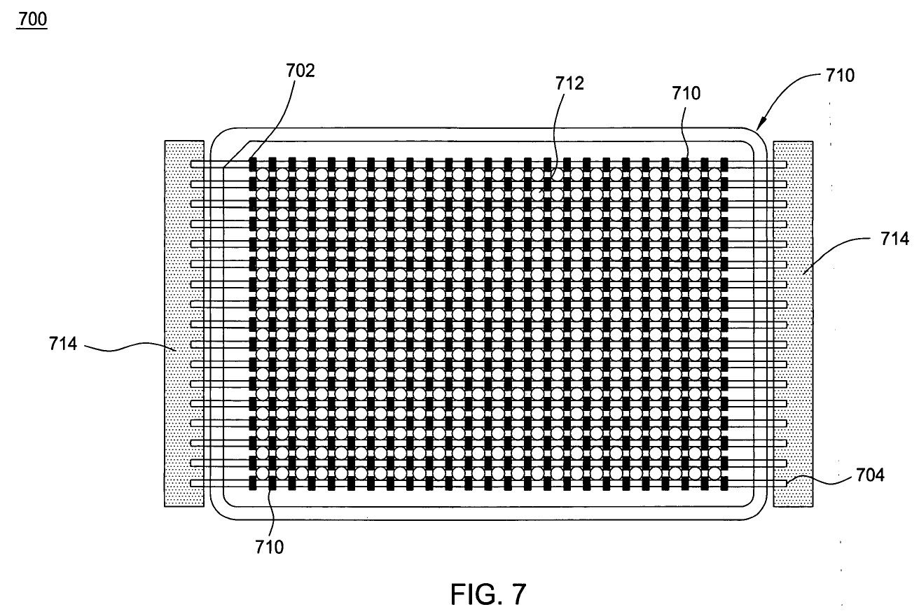

Referring to FIG. 7, a top plan view of the above described plasma devices configured and arranged in a standard microplate format 700 is provided. For example, the wells 712 and pitch between rows of wells of the microplate format 700 were sized to accommodate 96 openings for receiving a plurality of fluid handling probes. In another embodiment, the wells 712 and pitch are sized to accommodate 384 openings for receiving a plurality of probes, as depicted in FIG. 7. As another embodiment, the wells 712 and pitch are sized to accommodate 1536 openings for receiving a plurality of probes. The blocking members 720 are positioned between the wells 712 to allow for the probes 706 to be introduced between the dielectric barrier members 702 and the blocking members 720.

Microtiter members or microplates, similar to the one depicted in FIG. 7, are small, usually plastic, reaction vessels. The microplate 700 has a tray or cassette 710 covered with wells or dimples 712 arranged in orderly rows. These wells 712 are used to conduct separate chemical reactions during a fluid testing step. The large number of wells, which typically number 96, 384 (as shown in FIG. 7) or 1536, depending upon the well 712 size and pitch between rows of wells of the microplate, allow for many different reactions to take place at the same time. Microplates are ideal for high-throughput screening and research. They allow miniaturization of assays and are suitable for many applications including drug testing, genetic study, and combinatorial chemistry.

The microplate 700 has been equipped with an embodiment of the present invention. Situated in rows on the top surface of the microplate 700 and between the wells 712 are a plurality of elongated dielectric barrier members 702 similar to those described hereinabove and blocking members 712. The inner electrodes 704 of the elongated dielectric barrier members 702 are electrically coupled to the AC voltage source through contact planes 714 of the cassette 710.

The elongated dielectric barrier members 702 are each spaced apart in this particular embodiment a pitch of about 4.5 mm. In alternative embodiments, where the well count is 96, the members 702 are spaced apart a pitch of about 9 mm. In yet another embodiment, where the wells 712 numbered 1536, the pitch is 2.25 mm. During a cleaning step, the wells 712 of the microplate 700 do not necessarily function as liquid holding devices. Rather, the wells 712 are used to allow receiving space for the probes when the probes are fully introduced between the elongated dielectric barrier members 702. This matrix can accommodate ground electrodes as well such that non-conductive probes may be cleaned using the microplate 700 set up.

In operation, the microplate 700 is placed in, for example, a deck mounted wash station. In, for example, an automated microplate liquid handling instrumentation, the system performs an assay test. Then, at least the probe tips of the fluid handling device require cleaning. As such, the fluid handling device enters the wash station. A set of automated commands initiate and control the probes to be introduced to the microplate 700 proximate the elongated dielectric barrier members 702. At or about the same time, the AC voltage power source is initiated. Alternatively, the power source remains on during an extended period so that the system is ready to create a DBD.

During the power-on phase, as the probes are introduced to the dielectric members 702 and between the blocking members 720 of the microplate 700, dielectric barrier discharges are formed among the members 702, the blocking members 720 and the probes. In an embodiment where the probes are hollow, the reactive and energetic components or species of the plasma are repeatedly aspirated into the probes, using the fluid handling devices' aspirating and dispensing capabilities. The aspiration volume, rate and frequency are determined by the desired amount of cleaning/sterilization required.

Any volatized contaminants and other products from the plasma may be vented through the bottom of the microplate 700 by coupling the bottom of the tray 710 to a region of negative pressure such as with a modest vacuum. This vacuum may be in communication with the wells 712 and is capable of drawing down byproducts through to the bottom of the device and into an exhaust manifold (not shown) of the cleaning station test set up.

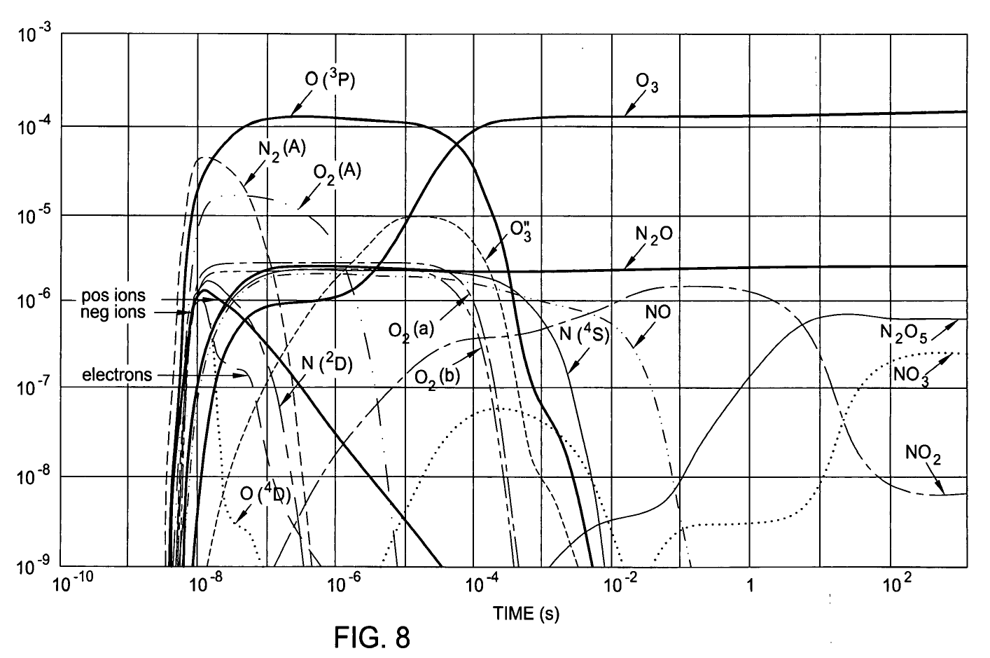

In an embodiment, ions, excited and metastables species (corresponding emitted photons), and free radicals are found in the atmospheric pressure plasma and remain long enough to remove substantially all of the impurities and contaminates left from the previous test performed by the fluid handling device's probes. These particle species remain longer (see FIG. 8) than the initial plasma formed from a DBD or micro-discharge and are therefore effective in cleaning the probes in preparation for the next test as the initially formed plasma itself.

In particular, FIG. 8 represents a graph of the relative concentrations of different particle species in time after the initiation of a single microdischarge forming atmospheric pressure plasma in air. Metastables are represented by N₂(A) and N₂(B). Free radicals are represented by O₃, O(³P), N(⁴S) and NO. Free radicals and metastables are represented by O(¹D) and N(²D). In non-equilibrium microdischarges, the fast electrons created by the discharge mechanism mainly initiate the chemical reactions in the atmospheric pressure plasma. The fast electrons can inelastically collide with gas molecules and ionize, dissociate and/or excite them to higher energy levels, thereby losing part of their energy, which is replenished by the electric field. The resulting ionic, free radical, and excited species can then, due to their high internal energies or reactivities, either dissociate or initiate other reactions.

In plasma chemistry, the transfer of energy via electrons to the species that take part in the reactions must be efficient. This can be accomplished by a short discharge pulse. This is what occurs in a microdischarge. FIG. 8 shows the evolution of the different particle species initiated by a single microdischarge in “air” (80% N₂, plus 20% O₂). The short current pulse of roughly 10 ns duration deposits energy in various excited levels of N₂ and O₂, some of which lead to dissociation and finally to the formation of ozone and different nitrogen oxides. After about 50 ns, most charge carriers have disappeared and the chemical reactions proceed without major interference from charge carriers and additional gas heating.

While the foregoing is directed to embodiments of the present invention, other and further embodiments of the invention may be devised without departing from the basic scope thereof, and the scope thereof is determined by the claims that follow.

1. An apparatus for cleaning objects using plasma, comprising:
a plurality of elongated dielectric barrier members, arranged adjacent each other and spaced apart to define predetermined gaps therebetween;
a plurality of inner electrodes, each contained within, and extending substantially along the length of, respective ones of the elongated dielectric barrier members; and
a plurality of blocking members arranged between the plurality of elongated dielectric barrier members and extending into the predetermined gaps therebetween.

2. The apparatus of claim 1, wherein each dielectric barrier member comprises a top and a bottom having a height “h” defined therebetween, and each inner electrode is positioned substantially equidistant between the top and bottom and extends between the top and bottom less than the height “h”.

3. The apparatus of claim 1, wherein the objects comprise a plurality of conductive probes, the probes arranged and configured to be introduced proximate the elongated dielectric barrier members and the blocking members.

4. The apparatus of claim 3, further comprising a voltage source electrically coupled to the inner electrodes for producing a dielectric barrier discharge among the conductive probes, the elongated dielectric barrier members and blocking members, whereby plasma is formed to clean at least a portion of the probes.

5. The apparatus of claim 3, wherein the elongated dielectric barrier members are arranged to define a plane.

6. The apparatus of claim 5, wherein the elongated dielectric barrier members are spaced apart from each other at substantially regular intervals to define substantially regular predetermined gaps therebetween.

7. The apparatus of claim 6, wherein each predetermined gap is sized to allow at least a portion of the conductive probes to be introduced between the elongated dielectric barrier members and the blocking members.

8. The apparatus of claim 7, wherein each predetermined gap is sized from about 0 mm to about 10 mm.

9. The apparatus of claim 1, wherein each elongated dielectric barrier member is arranged in parallel to the next adjacent elongated member.

10. The apparatus of claim 1, further comprising a plurality of ground electrodes, each arranged within each of the predetermined gaps.

11. The apparatus of claim 10, wherein the objects comprise a plurality of non-conductive probes, the probes arranged and configured to be introduced proximate the elongated dielectric barrier members, blocking members and ground electrodes.

12. The apparatus of claim 11, further comprising a voltage source electrically coupled to the inner electrodes for producing a dielectric barrier discharge between the ground electrodes, the elongated dielectric barrier members and blocking members, whereby plasma is formed to clean at least a portion of the non-conductive probes.

13. The apparatus of claim 10, wherein the shape of the ground electrodes is selected from the group consisting of spherical, square, rectangular, oval, polygonal, triangular and irregularly geometric.

14. The apparatus of claim 1, wherein the elongated dielectric barrier members are vertically canted.

15. The apparatus of claim 14, wherein the blocking members are wedged shaped and are arranged to be friction fit within the canted elongated dielectric barrier members.

16. The apparatus of claim 15, wherein the objects comprise a plurality of non-conductive probes, the probes arranged and configured to be introduced proximate the elongated dielectric barrier members and between the wedged-shaped blocking members.

17. The apparatus of claim 1, wherein the blocking members are arranged and shaped within the predetermined gap such that the space between adjacent blocking members decreases from the top of the blocking members to the bottom of the blocking members.

18. The apparatus of claim 1, wherein the elongated dielectric barrier members are arranged in a microtiter member matrix format.

19. The apparatus of claim 1, wherein the elongated dielectric barrier members are arranged in a non-planar configuration.

20. A method for cleaning a plurality of non-conductive objects, comprising:
providing a plurality of elongated dielectric barrier members, each having inner electrodes arranged therein, the elongated dielectric barrier members spaced apart to define a predetermined gap therebetween;
providing blocking members within the predetermined gaps;
providing a plurality of ground electrodes adjacent the elongated dielectric barrier members;
introducing non-conductive objects proximate the elongated dielectric barrier members, the blocking members and the ground electrodes; and
generating a dielectric barrier discharge to form plasma among the elongated dielectric barrier members, blocking members and respective ground electrodes for cleaning at least a portion of each of the non-conductive objects.

21. The method of claim 20, wherein the plasma comprises energetic and reactive particles selected from a group consisting of electrons, ions, excited and metastable species, and free radicals.

22. The method of claim 20, wherein the plasma comprises energetic and reactive particles selected from a group consisting of: excited and metastable species of N₂, N, O₂, O; free radicals such as OH, NO, O, and O₃; and ultraviolet photons ranging in wavelengths from 200 to 400 nanometers resulting from N₂, NO, and OH emissions.
